(19) United States
(12) Patent Application Publication
(10) Pub. No.: US 2007/0068550 A1
(43) Pub. Date: Mar. 29, 2007

(54) INTERPROXIMAL SPACE CLEANING TAPE

(75) Inventor: Zathaya Zhiwzhinda, Nonthaburi Province (TH)

Correspondence Address: VOLPE AND KOENIG, P.C., UNITED PLAZA, SUITE 1600, 30 SOUTH 17TH STREET, PHILADELPHIA, PA, 19103, US

(73) Assignee: Doctor Zath Co., Ltd., Nonthaburi Province (TH)

(21) Appl. No.: 11/551,813

(22) Filed: Oct. 23, 2006

(51) Int. Cl. A61C 15/00

(52) U.S. Cl. 132/321

(57) ABSTRACT

An interproximal space cleaning tape is provided. The tape is preferably made of a soft, durable, elastic material with a homogenous texture, such as polyethylene (PE), polypropylene (PP), polyamide (PA), polystyrene (PS), nylon, polytetrafluroethylene (PTFE) or combinations thereof, so that the tape is soft on the gums and will not fray during use. The tape is easy to grip because it is wide and not slippery. The tape's relative thinness allows it to easily move in the interproximal space. Its relative width allows it to clean the interproximal space with one pull i.e., no up and down movement is needed.

### FIELD OF INVENTION

The present invention relates to the field of oral hygiene products. Specifically it deals with a thinner, wider, smoother and stronger dental tape for cleaning the space between teeth.

### BACKGROUND

Currently two products are commonly used to clean in between adjacent teeth; i.e., in the interproximal space, namely dental floss and dental tape. Dental floss is a continuous, long, round bundle of microfilaments, usually, thin nylon filaments, plaited together. Some dental floss is coated with wax. To clean teeth and the interproximal space, a user cuts a length of floss, grips the floss adjacent its opposite ends, places a portion of the floss in the interproximal space, moves the floss back and forth, up and down, and over and around the teeth.

Dental floss typically has a diameter of about only 0.5 millimeters, which makes it difficult to firmly grip, especially if the floss is waxed-coated. To get a firm grip, a user often must wrap the ends of the floss around his or her fingers. As a result of its small diameter and high tensile strength, the floss may cut into or hurt the user's fingers. And, after use, the wrapped ends of the floss are wasted. Further, because of floss's relatively small diameter it is capable of covering only a small surface area. Therefore, in order to effectively clean the entire interproximal space and teeth, a user must move the floss up and down repeatedly. This repeated movement and abraision can damage gums and cause the microfilaments that make up the floss to unwind rendering the floss unusable.

To overcome the flaws of dental floss, the industry produced dental tape. Dental tape is a long, continuous rectangular strand of ribbon. Like dental floss, to clean the interproximal space and teeth, a user moves the dental tape back and forth and up and down between adjacent teeth. Less up and down iterations are required because dental tape is rectangular and thicker than floss and thus covers a greater surface area. Because dental tape is thicker, it is easier to grip and dental tape is less likely to fray. Finally, its shape allows a user to grip it without wrapping as much of it around his or her fingers. But dental tape generally, is about 0.1 millimeters thick and therefore, it does not fit and move smoothly within the space between teeth. Also, dental tape is often only 1-2 millimeters wide. Therefore, it still requires many up-and-down iterations and while it is easier to grip than floss, it is still prone to slipping from a user's fingers.

There is a need for an interproximal space cleaning tape that is capable of effectively cleaning the interproximal space with fewer iterations, that moves smoothly within the interproximal space, that is easy to grip without wrapping around fingers, that will not harm gums, and that will not fray.

### SUMMARY

The present invention satisfies the above-listed needs. The present invention is an interproximal space cleaning tape having a width of no more than 50 millimeters and a thickness of no more than 150 microns. In another aspect, the present invention is an interproximal space cleaning tape and dispenser having interproximal space cleaning tape of a width of no more than 50 millimeters and a thickness of no more than 150 microns; a dispenser having a main body having an outlet; a spool coupled to the main body and a cutter on the main body, the interproximal space cleaning tape being wrapped around the spool and extended to the cutter.

The tape is wide enough to clean the interproximal space with one pull through the space and without the need for up and down iterations but thin enough that it glides smoothly through the interproximal space.

### BRIEF DESCRIPTION OF THE DRAWINGS

FIG. 1A is a perspective view of a preferred embodiment of the interproximal space cleaning tape of the present invention on a dispenser.

FIG. 1B is an enlarged perspective view of one end of the interproximal space cleaning tape shown in FIG. 1A.

FIG. 2 is a perspective view of a user holding a preferred embodiment of the interproximal space cleaning tape of the present invention.

FIG. 3 is a perspective view of a user using the interproximal tape of the present invention.

FIG. 4 is a perspective view of a user using the interproximal tape of the present invention.

FIG. 5 is a perspective view of a user using the interproximal tape of the present invention.

FIG. 6A is a perspective view of an alternate embodiment of the interproximal space cleaning tape of the present invention on a dispenser.

FIG. 6B is an enlarged perspective view of one end of the interproximal space cleaning tape shown in FIG. 6A.

### DETAILED DESCRIPTION OF THE PREFERRED EMBODIMENTS

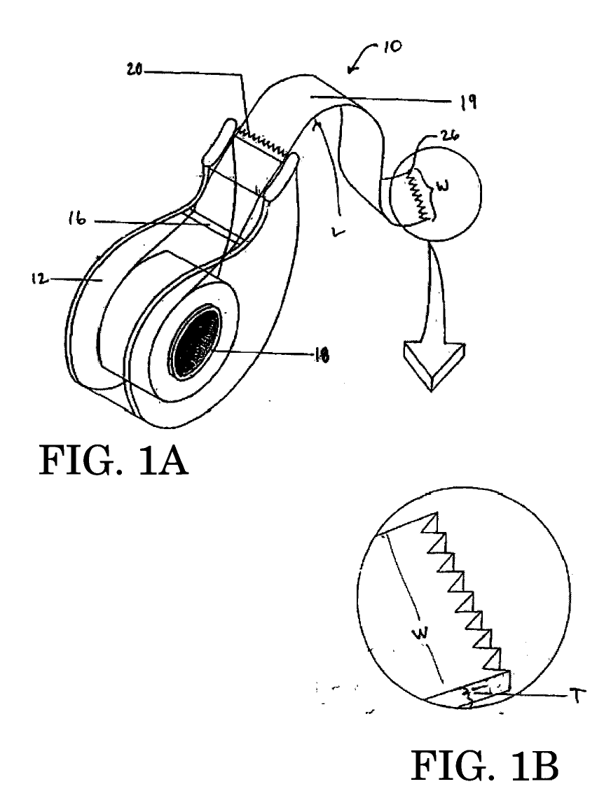

FIGS. 1-5 show a preferred embodiment of the interproximal space cleaning tape 10 of the present invention. As shown in FIGS. 1A and 1B, the tape 10 has a width “W”, a thickness “T” and a length “L”. Preferably, the tape 10 is comprised of polyethylene (PE) and has a homogenous texture so that the tape 10 is soft, durable, and elastic and will not fray during use. The tape 10 may be comprised of plastic resin and other polymers such as polypropylene (PP), polyamide (PA), polystyrene (PS), nylon, polytetrafluroethylene (PTFE), and several others. The tape 10 is not slippery even when wet because it does not need to be coated with wax to keep filaments together. Further, because the tape 10 has a non-woven homogenous texture and is durable, will not fray during use. Additionally, the tape 10 can be coated to include fluoride to protect teeth and/or flavoring (e.g. mint, citrus, etc.) to freshen breath. The tape 10 can alternatively comprise a coloring and/or other indicia 41 (e.g. length indication markers, logos, inspirational messages, etc.).

As shown in FIG. 1A, the tape 10 is preferably contained within a dispenser 12. The dispenser 12 comprises a preferably rigid main body 14, an outlet 16 in the main body 14, a spool 18 within the main body 14 and a cutter 20 coupled to the main body 14. A toothed cutter 20 is shown, however, it is understood that other cutters as well as dispensers may be used. Furthermore, it is understood that the tape 10 can be precut to predetermined lengths and dispensed piece by piece. Alternatively, the tape 10 can be scored for easy tearing into sections of predetermined lengths so that no cutter is required.

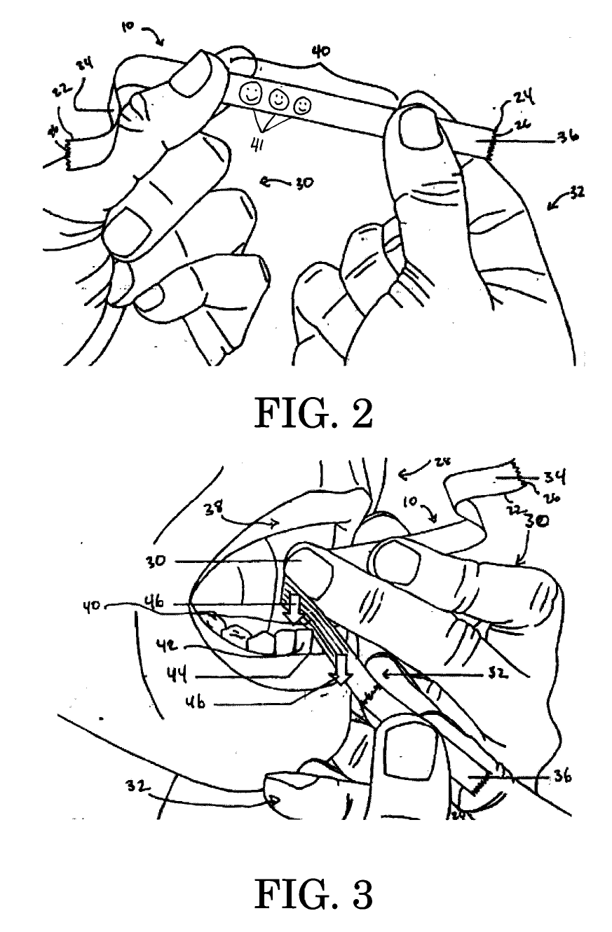

The interproximal space cleaning tape 10 is wound around the spool 18 and a portion of the tape 10 is extendable from the spool 18, through the outlet 16, to the cutter 20. Pulling an extended portion 19 causes the tape 10 to rotate about the spool 18 and provides an increasingly-longer extended portion 19 of tape 10. The teeth 20 allow a user 28 to cut the extended portion 19 at various desired lengths by pulling the tape 10 down over the cutter 20. Preferably, the tape 10 is cut at a length of 13-15 centimeters. As shown in FIGS. 1A, 1B and 2, after being cut, the tape 10 has first 22 and second 24 ends with jagged edges 26. Alternate dispensers can be used that provide clean cuts without jagged edges.

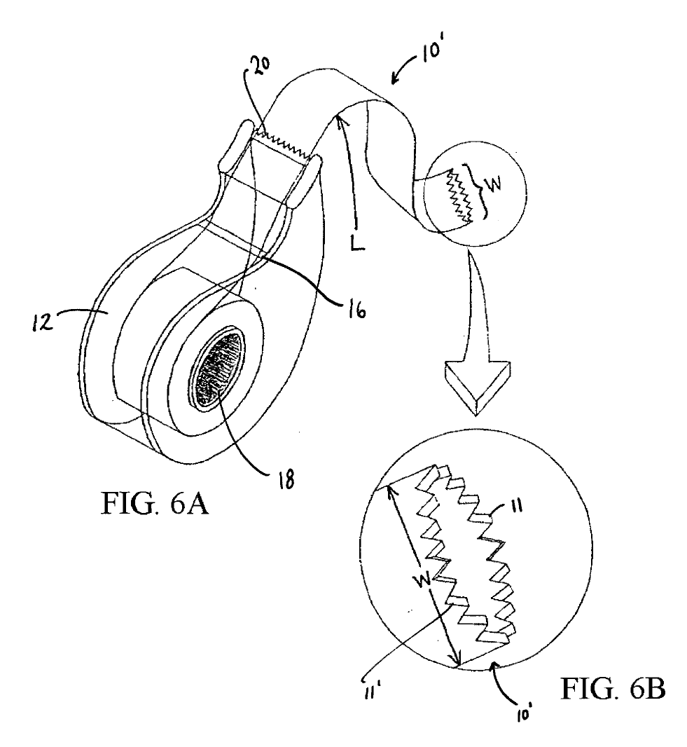

FIGS. 6A and 6B show an alternate embodiment of the tape 10 of FIGS. 1A and 1B. The tape 10′ of FIGS. 6A and 6B is comprised of two separate plies 11, 11′ and a hollow through passage therebetween. Alternatively, the tape 10′ can be formed initially as a tube and subsequently pressed flat to form the tape 10′. This provides a stronger tape by incorporating multiple layers but also allows the tape to remain thin.

Owing to the tape's thinness, the dispenser 12 can accommodate great lengths of interproximal space cleaning tape 10. A typical length can range between 10 to 100 meters.

The preferred method of using the interproximal tape 10 is shown in FIGS. 2-5. As shown in FIG. 3, a user grabs the tape 10 that was cut from the dispenser 12 (FIG. 1A), preferably with the index fingers and thumbs 30, 32, adjacent the opposite first 22 and second ends 24. For cleaning interproximal space 44 located on the right side of the mouth 38 (FIG. 3), preferably, the tape 10 is longer at the first end 22, creating a longer portion 34. In other words, the length of the tape 10 between the first end 22 and the left thumb and index finger 30 is longer than the distance between the second end 24 and the right thumb and index finger 32 (the shorter portion 36), which is shown in FIG. 2. For cleaning interproximal space 44 located on the left side of the mouth 38, preferably, the length of the tape 10 between the second end 24 and the right thumb and index finger 32 is longer than the distance between the first end 22 and the left thumb and index finger 30. Regardless of which side of the mouth 38 the user 28 is cleaning, as shown in FIG. 2, holding the tape 10 between the fingers adjacent the first 22 and second 24 ends creates a middle portion 40. This middle portion 40 is preferably 3-5 centimeters but may be different lengths.

As shown in FIG. 3, the user 28 then places a middle portion 40 in between two adjacent teeth 42; in the interproximal space 44, which is shown by the downward arrows 46. The longer portion 34 is inside the mouth 38 and the shorter portion 36 is outside the mouth 38. The width “W” of the interproximal space 44 generally corresponds to the length of the adjacent teeth 42 (i.e., the distance from the gums to the top of the teeth 42), which is usually between 2.5 and 50 millimeters. In other embodiments, the width “W” may be anywhere from 1 to 50 millimeters. This makes the tape 10 wide enough to contact the entire surface area of the two adjacent teeth 42 between which the tape 10 is cleaning allowing for one cleaning iteration as described below.

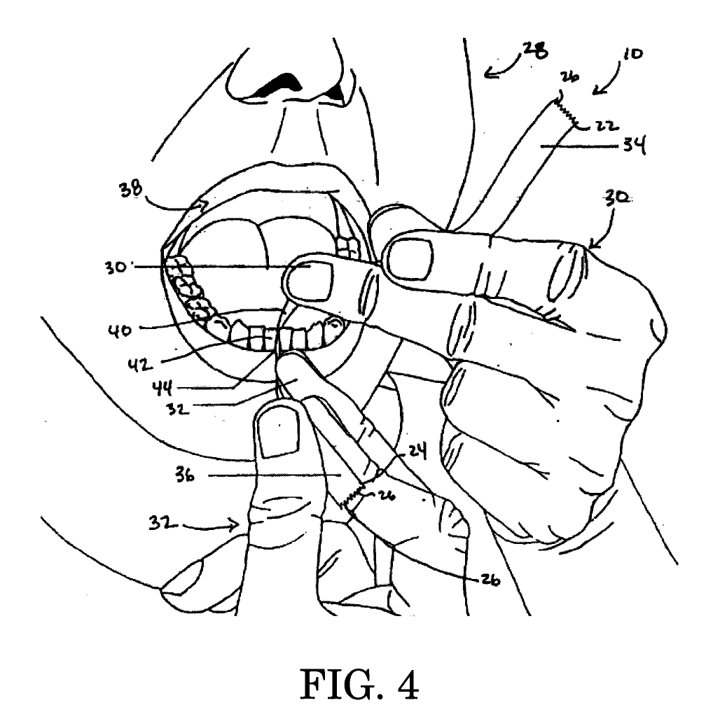

As shown in FIG. 4, the user 28 then presses the tape 10 into the interproximal space 44. Insertion of the tape 10 in to the interproximal space 44 is simple because the tape 10 is thin. The thickness “T” of the tape can be between 3.0-150 microns.

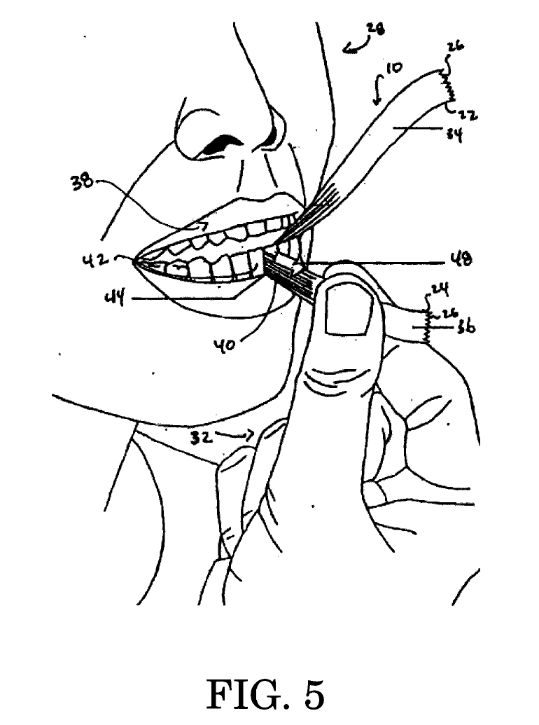

As shown in FIG. 5, the user 28 pulls the shorter portion 36 away from the mouth 38 until the middle portion 40 and longer portion 34 pass completely through the interproximal space 44. This pulling motion is shown by the arrow 48. It is easy to pull the tape 10 through the interproximal space 44 because of the tape's 10 relative thickness. Pulling the tape 10 through the interproximal space 44 one time is enough to completely clean the interproximal space 44. No further iterations are required, which substantially reduces the possibility of damaging the user's 28 gums and saves time. Unlike dental floss, the user 28 does not have to move the tape 10 up and down (relative to the bottom teeth 42) to fully clean the interproximal space 44.

Having thus described in detail a preferred selection of embodiments of the present invention, it is to be appreciated and will be apparent to those skilled in the art that many physical changes could be made in the apparatus without altering the inventive concepts and principles embodied therein. The present embodiments are therefore to be considered in all respects as illustrative and not restrictive, the scope of the invention being indicated by the appended claims rather than by the foregoing description, and all changes which come within the meaning and range of equivalency of the claims are therefore to be embraced therein.

What is claimed is:

1. A non-woven interproximal space cleaning tape comprising a thickness between 3 and 150 microns and a width between 2.5 and 50 millimeters, such that the tape is firmly graspable by a person's finger and thumb.

2. The interproximal space cleaning tape of claim 1, wherein the tape is comprised of a material selected from the group consisting of polyethylene (PE), polypropylene (PP), polyamide (PA), polystyrene (PS), nylon, polytetrafluroethylene (PTFE), and combinations thereof.

3. The interproximal space cleaning tape of claim 1, wherein the tape further comprises fluoride.

4. The interproximal space cleaning tape of claim 1, wherein the tape further comprises flavoring.

5. The interproximal space cleaning tape of claim 1, wherein the tape further comprises indicia.

6. The interproximal space cleaning tape of claim 5, wherein the indicia is a logo, length indicator, message or combinations thereof.

7. The interproximal space cleaning tape of claim 1, wherein the tape has a length that is variable.

8. The interproximal space cleaning tape of claim 7, wherein the tape is housed in a dispenser, the dispenser comprising:
a main body;
a spool coupled to the main body about which the tape is wound;
an outlet through which the tape is fed; and
a cutter on the main body.

9. An interproximal space cleaning tape comprising:
a thickness of no more than 150 microns; and
a width of no more than 50 millimeters, such that the tape is firmly graspable by a user's finger and thumb.

10. The interproximal space cleaning tape of claim 9 wherein the width is 2.5 to 50 millimeters.

11. The interproximal space cleaning tape of claim 9 wherein the thickness is 3 to 150 microns.

12. The interproximal space cleaning tape of claim 9 wherein the tape is comprised of polyethylene (PE), polypropylene (PP), polyamide (PA), polystyrene (PS), nylon, polytetrafluroethylene (PTFE) or combinations thereof.

13. The interproximal space cleaning tape of claim 9, wherein the tape further comprises fluoride.

14. The interproximal space cleaning tape of claim 9, wherein the tape further comprises flavoring.

15. The interproximal space cleaning tape of claim 9, wherein the tape further comprises indicia.

16. The interproximal space cleaning tape of claim 15, wherein the indicia is a logo, length indicator, message or combinations thereof.

17. The interproximal space cleaning tape of claim 9, wherein the tape has a length that is variable.

18. The interproximal space cleaning tape of claim 9, wherein the tape is comprised of two plies next to each other defining a hollow through passage therebetween.

19. The interproximal space cleaning tape of claim 17, wherein the tape is housed in a dispenser, the dispenser comprising:
a main body;
a spool coupled to the main body about which the tape is wound;
an outlet through which the tape is fed; and
a cutter on the main body.

20. A method of using an interproximal space cleaning tape, the method comprising:
providing an interproximal space cleaning tape comprising:
a non-woven interproximal space cleaning tape having a width of no more than 50 millimeters and a thickness of no more than 150 microns;
cutting the interproximal space cleaning tape to a desired length having opposite first and second ends;
holding the interproximal space cleaning tape at the opposite first and second ends;
placing the interproximal space cleaning tape between two teeth; and
moving the interproximal space cleaning tape forward and rearward.
